(19) United States
(12) Patent Application Publication
(10) Pub. No.: US 2011/0158441 A1
(43) Pub. Date: Jun. 30, 2011

(54) WIRELESS SPEAKER UNITS WITH IMPROVED BATTERY LIFE

(75) Inventor: Sanjay Batra, Chicago, IL (US)

(73) Assignee: MOTOROLA, INC., Schaumburg, IL (US)

(21) Appl. No.: 12/650,769

(22) Filed: Dec. 31, 2009

(51) Int. Cl. H04R 5/02; H04R 29/00; H04B 17/00; H04B 3/00

(52) U.S. Cl. 381/311; 381/59; 455/67.11; 381/77; 455/41.2

(57) ABSTRACT

A method is provided for managing signal distribution in a wireless speaker unit. The method includes monitoring a power level of the first wireless device; receiving, at the first wireless device, a first signal from the base unit if a power level of the first wireless device has not reached a threshold level; transmitting wirelessly a second signal, derived from the first signal, from said first wireless device to the second wireless device if a power level of the first wireless device has not reached the threshold level; receiving, at the second wireless device, the first signal from the base unit if the power level of the first wireless device reaches the threshold level; and transmitting wirelessly a third signal, derived from the first signal, from the second wireless device to the first wireless device if the power level of the first wireless device reaches the threshold level.

### TECHNICAL FIELD

The present invention relates generally to the field of communication systems and more particularly to wireless speaker devices and communications associated therewith.

### BACKGROUND

Portable audio devices are gaining in popularity. Such audio devices may include cellular telephones and smart phones, as well as dedicated music devices such as MP3 players. The audio device may be paired with a speaker unit to provide audio output to a user. The speaker unit may particularly be wireless with respect to the audio device (i.e., the speaker unit is not connected to audio device by physical means such as wires or optical cables) and operate in a personal wireless network, such as that defined by a Bluetooth™ specification. Typically, built-in Bluetooth modules are utilized for establishing wireless connections between the audio device and the speaker unit. For example, the Bluetooth Advanced Audio Distribution Profile (A2DP) defines the protocols and procedures for distributing high-quality audio content in mono or stereo channels, and various integrated circuits are commercially available that operate in accordance with the Bluetooth specifications.

The wireless speaker unit may, for example, be a “headset” with a pair of wireless earpiece devices that support both listening to stereo music and conducting phone calls. Each of the devices in the wireless speaker unit is typically dependent upon a battery to provide adequate power for the devices to operate. The rate at which battery power is consumed in each wireless device may vary greatly in dependence on the types of functions performed by each device and the frequency of use of those functions. The useful power source life of the speaker unit as a whole may be unnecessarily limited by this uneven power consumption since both devices may be necessary for certain functions, such as stereo functions.

Accordingly, it is desirable to provide a wireless speaker unit with improved battery life. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, a method is provided for managing signal distribution in a wireless speaker unit operable with a base unit. The speaker unit includes a first battery powered wireless device and a second battery powered wireless device. The method includes monitoring a power level of said first wireless device; receiving, at said first wireless device, a first signal from the base unit if a power level of said first wireless device has not reached a threshold level; transmitting wirelessly a second signal, derived from said first signal, from said first wireless device to said second wireless device if a power level of said first wireless device has not reached said threshold level; receiving, at said second wireless device, said first signal from the base unit if said power level of said first wireless device reaches said threshold level; and transmitting wirelessly a third signal, derived from said first signal, from said second wireless device to said first wireless device if said power level of said first wireless device reaches said threshold level.

In accordance with another exemplary embodiment, a wireless communication system is provided. The wireless communication system includes a first wireless device configured to operate in an intermediary mode such that said first wireless device receives a first stereo channel and a second stereo channel from a source, produces a signal for a transducer in accordance with said first stereo channel, and transmits said second stereo channel over a wireless link to a second wireless device. The first wireless device includes a power monitor operable to monitor a power level of a battery powering said first wireless device; and the first wireless device includes a controller operable to communicate a mode switch with the second wireless device in response to said power level dropping below a threshold level. The mode switch changes said mode of said first wireless device from intermediary mode to end mode such that said first wireless device ceases receiving said first signal and transmitting said second signal, and initiates receiving a third signal.

### BRIEF DESCRIPTION OF THE DRAWINGS

The present invention will hereinafter be described in conjunction with the following drawing figures, wherein like numerals denote like elements, and wherein:

FIG. 1 is a block diagram of a wireless communication system in accordance with an exemplary embodiment; and

FIG. 2 is a flowchart of a method for managing signal distribution in a wireless communication system in accordance with an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Broadly, exemplary embodiments disclosed herein provide a wireless communication system in which a base unit wirelessly transmits audio information to a wireless speaker unit. The audio information can be, for example, first and second channel signals of a stereo transmission. The wireless speaker unit can include first and second wireless devices that each has a depletable power source. During operation, the first wireless device of the wireless speaker unit can receive the audio information from the base unit, play the first channel signal of the stereo transmission, and forward the second channel signal of the stereo transmission to the second wireless device. The first wireless device further includes a power monitor such that when the power source reaches a predetermined threshold, the second wireless device of the wireless speaker unit receives the audio information from the base unit, plays the second channel signal of stereo transmission, and forwards the first channel signal of the stereo transmission to the first wireless device. By distributing the signal processing of the audio information in this manner, the wireless speaker unit may have a longer battery life.

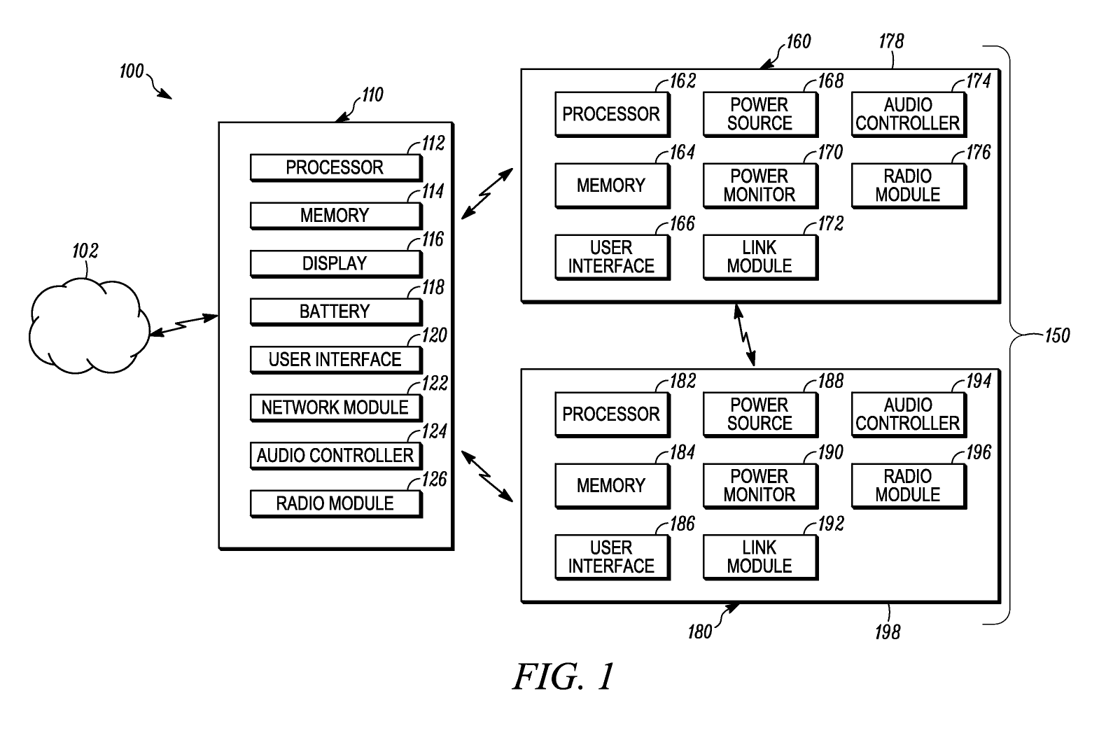

FIG. 1 is a block diagram of a wireless communication system 100 in accordance with an exemplary embodiment. The wireless communication system 100 includes a base unit 110 and a wireless speaker unit 150. As discussed in greater detail below, the wireless speaker unit 150 may include a first wireless device 160 and a second wireless device 180 that are configured to communicate with the base unit 110 using a communication protocol such as the Bluetooth protocol. As also discussed in greater detail below, in one exemplary embodiment, the wireless speaker unit 150 may be embodied as a headset in which the first and second wireless devices 160, 180 are wearable earpieces that enable wireless communication with the base unit 110, and enable wireless communication between the first and second wireless earpieces.

The base unit 110 is an audio transmitting device, such as a cellular phone, smart phone, MP3 player, iPod™ player, personal digital assistant (PDA), mobile handset, personal computer (PC), gaming device, television, radio, or the like. In the illustrated exemplary embodiment, the base unit 110 is a cellular phone that exchanges information with a network 102, although it should be noted again that the base unit 110 may be any type of audio transmitting device, including one that does not communicate with an external network such as network 102. The network 102 may be, for example, a wireless telecommunication network, the Internet, a public switched-phone network, and the like, and the type of information exchanged with the network 102 may include voice communication, digital data, SMS messaging, MMS messaging, Internet access, multi-media content access, voice over internet protocol (VoIP), and other conventional communication standards and protocols.

It is envisioned that the base unit will include a controller, one or more transceivers, and a power source. In one exemplary embodiment, the base unit 110 includes a processor 112, a memory 114, a display 116, a power source 118, a user interface 120, an audio controller 124, and a radio module 126. In general, a controller can be implemented by the processor 112 controlling the operation of the base unit 110 in accordance with computer instructions stored in memory 114. The memory 114 may additionally store audio files, either in a permanent format or streamed from the network 102, for output to the audio controller 124 of the base unit 110 or wireless speaker unit 150, as discussed below.

The audio controller 124 may generally include a variety of audio output and input means, such as a speaker and/or microphone, or other transducers for converting audible signals to and from digital signals. The display 116 may include an liquid crystal display (LCD) or other suitable device to display information to the user, while the user interface 120 may include a keyboard, keys, touchscreen input, or combination of input mechanisms for receiving and making telephone calls and supporting other interactions between the user and base unit 110. If functioning as a telephone, the network module 122 enables the base unit 110 to communicate with the network 102. As such, the network module 122 may transmit, receive, modulate, and/or demodulate communications to and from the network 102. It can thus be seen that the network module is optional, and supports communications to wide area networks (WAN), such as cellular networks, or local area networks (LAN), such as 802.11 networks, using conventional means. These communications may us RF signals or signals in other spectrums.

The radio module 126 enables the base unit 110 to communicate with the wireless speaker unit 150. Collectively, the base unit 110 and wireless speaker unit 150 form a personal area network (PAN) or piconet, scatter-net, or other type of distributed network to communicate with one another, if located relatively close together in the immediate area of the user. In particular, the wireless speaker unit 150 includes first and second wireless devices 160, 180 that cooperate to deliver audio information from the base unit 110 to the user. As discussed in greater detail below, each of the first and second wireless devices 160, 180 may be arranged and configured to operate in one or more modes, including an intermediary mode and an end mode, based on the setting of the wireless speaker unit 120. Communication between the base unit 110 and wireless speaker unit 150, particularly with respect to the first and second wireless devices 160, 180, will be described in greater detail after a description of the wireless speaker unit 150. It can thus be seen that the radio module 126 supports a wireless link between the base unit and the speaker unit.

It is envisioned that the first wireless device 160 will include a controller, one or more transceivers, an audio circuit and a power source. In the exemplary embodiment of FIG. 1, the first wireless device 160 includes a processor 162, a memory 164, a user interface 166, a power source 168, a power monitor 170, a link module 172, an audio controller 174, and a radio module 176 arranged within a housing 178. Depending on the embodiment, additional components may be provided or certain components omitted. In general, the first wireless device 150 may be embodied, for example, as a wireless earpiece or other type of wireless speaker. The first wireless device 160 may be assembled from discrete components, or implemented in one or more integrated circuits, or it may be assembled from a combination of discrete components and integrated circuit components. The memory 164 may be integral with the processor 162.

The processor 162 controls the operation of the first wireless device 160 in accordance with computer instructions stored in memory 164 to provide a controller for the first wireless device 160. The memory 164 may be arranged and configured to store information to be used by other components of the first wireless device 160. For example, the memory 164 may store any information related to the user interface 166, power source 168, power monitor 170, link module 172, audio controller 174, and radio module 176.

The user interface 166 may be arranged and configured to accept input from a user and to convey information to a user. For example, the user interface 166 may include one or more input buttons and/or switches on a wireless headset or a wireless earpiece. Such user inputs may be associated with, for example, audio and telephone control functions.

The power source 168 may be any suitable power source, including one or more built-in or removable batteries, disposable and/or rechargeable batteries, one or more battery cells, or the like, to supply electricity to the first wireless device 160. For example, in one exemplary implementation, the power source 168 includes one or more rechargeable lithium ion battery cells. Other embodiments may be advantageously employed with other types of power sources, such as a hydrogen fuel cell, a solar cell, or other power supply generating a varying, or otherwise depleting, supply of power.

The power monitor 170 may be arranged and configured to monitor the power source 168. As such, the power monitor 170 may be configured to provide an indication and/or a trigger when the level of power for the power source 168 reaches a threshold level, as discussed in greater detail below. The power monitor 170 can monitor any operating characteristic of the first wireless device 160 as a measure of the power source 168. In one exemplary implementation, the power monitor 170 may monitor the level of power for the power source 168, including the voltage and/or current level of the power source 168. It is envisioned that the power monitor 170 can be integrated in the controller of the first wireless device 160, and thus implemented by processor 160 and memory 164, or it may be discrete. It is further envisioned that the power monitor 170, processor 162, and memory 164 can be implemented in a single integrated circuit.

The audio controller 174 may include amplifiers and transducers, such as speakers or microphones. More particularly, the audio controller 174 may receive audio information from base unit 110 or second wireless device 180 (e.g., from the radio module 176 as discussed below), process the audio information, such as by decoding and amplifying, to generate an audio signal that drives a transducer to produce audible signals that are based on the audio information. Similarly, the audio controller 174 may receive audible signals from the user using a transducer that converts the audible signals to audio signals, and process the signal for transmission from the first wireless device 160 to base unit 110.

The first wireless device 160 receives and transmits audio and/or data signals via the radio module 176, which may, for example include one or more wireless radio frequency (RF) transceiver, and may for example in include one Bluetooth transceiver, multiple Bluetooth transceivers, or one or more other wireless transceivers. It is envisioned that the wireless link will be a short range wireless link, and those skilled in the art will recognize that the Bluetooth specification provides protocols for pairing devices, establishing master and slave relationships, and the like. Those skilled in the art will recognize that other short range wireless means can be used to communicate between the base unit and the speaker unit. As such, the radio module 176 may include one or more transceivers, or receivers and transmitters, or the like, and as used herein transceiver refers to a transceiver, a transmitter and receiver, or discrete components that receive and transmit information. The information from the base unit 110 received by the first wireless device 160 or the second wireless device 180 may also be encoded and decoded, modulated and demodulated, or otherwise processed as appropriate, according to communication standard by which the signals are communicated, such as the Bluetooth specification.

The link module 172 of the first wireless device 160 may be arranged and configured to control the first wireless device's connection over one or more wireless links with one or more devices, including wireless links with the base unit 110 and the second wireless device 180. In one exemplary embodiment, the link module 172 may control operation according to a protocol to establish a link with another wireless device by exchanging link parameters that may define the characteristics of the links and/or define the characteristics of the information being communicated using the wireless links. For example, the exchange may be used to pair devices, establish master and slave relationships with paired devices, and change master and slave relationships. The link parameters may include address information for a device such as, for example, a medium access control (MAC) address, an internet protocol (IP) address, or other types of addresses. The link parameters may also include timing information, including timing information associated with a clock in a device and timing offset information. For instance, the timing information may include the clock information for a master device and the timing offset information used by a slave device to apply to the master device timing sequence. The link parameters may include modulation information, which may include packet type information and the type of modulation used in the packets. In one exemplary implementation, the link module 172 may use the Bluetooth protocol to establish such links, establish master and slave relationships, and enable communication. Those skilled in the art will recognize that other wireless protocols may alternatively be used. The link module 172 may be implemented by the processor 162 using programs stored in memory 164.

The link module 172 may further be configured to communicate the link parameters to another device and to transfer control of a wireless link to the other device. For example, the first wireless device 160 may establish a first wireless link with the base unit 110 using the link module 172. The first wireless device 160 may then establish a second wireless link with a second wireless device using the link module 172. The link module 172 may communicate the link parameters associated with the first wireless link to the second wireless device 180 to enable the second wireless device to listen in on the first wireless link. The link module 172 may then transfer control of the first wireless link to the second wireless device 180 such that the second wireless device 180 and the base unit 110 are communicating using the first wireless link. The first wireless device 160 may then terminate the first wireless link with the base unit 110 and receive information from the second wireless device 180 via the second wireless link. Further examples of this procedure are discussed in greater detail below.

In one exemplary embodiment, it is envisioned that the base unit 110 and the first wireless device 160 can establish a master and slave pairing relationship, respectfully (i.e., the base unit 110 is master), for communications between the base unit 110 and the first wireless device 160. The first wireless device 160 and the second wireless device 180 will set up a master and slave pairing relationship, respectfully, for stereo audio generation. When the power level of the first wireless device 160 drops below a threshold level, the first and second devices 160, 180 will change modes, such that the base unit 110 and the second wireless device 180 will establish a master and slave pairing relationship, respectfully, and the second wireless device 180 and the first wireless device 160 will set up master and slave pairing relationship, respectfully.

The second wireless device 180 may include the same and/or similar components as the first wireless device 160, where those components of second wireless device 180 may be arranged and configured to function as described above with respect first wireless device 160. For example, the second wireless device 180 may include a processor 182, memory 184, a user interface 186, a power source 188, a power monitor 190, a link module 192, an audio controller 194, and a radio module 196 arranged in a housing 198, each of which may function the same as or similar to the similarly named components of the first wireless device 160. In one exemplary implementation, the second wireless device 180 may be a Bluetooth-enabled device and the wireless links established by the link module 192 may use the Bluetooth protocol to establish the links and to communicate information between the second wireless device 180 and other Bluetooth-enabled devices, including the base unit 110 and the first wireless device 160.

As will now be described, the first and second wireless devices 160, 180 may selectively function in accordance with first and second settings. In a first setting, the first wireless device 160 functions in an intermediary mode, and the second wireless device 180 functions in an end mode. As such, in the first setting, the first wireless device 160 establishes a wireless link with the base unit 110 to receive audio information from the base unit 110. As discussed above, the first wireless device 160 is configured to produce an audible sound based on the audio information. The first wireless device 160 also establishes a wireless link with the second wireless device 180 and forwards at least a portion of the audio information to the second wireless device 180, which is operating in the end mode. The second wireless device 180 receives the audio information and produces an audible sound based on the audio information. In one exemplary embodiment, the intermediary mode may be referred to as the “master” mode, and the end mode may be referred to as the “slave” mode.

In this example, the first wireless device 160, which is operating in the intermediary mode, may consume more power and/or consume power faster than the second wireless device 180, which is operating in the end mode. If the first wireless device 160 continues to operate in the intermediary mode, the first wireless device 160 may run out of power before second wireless device 180. Thus, if this condition persists, the overall useful power life of the wireless speaker unit 150 may be reduced, even though the second wireless device 180 may still have power remaining.

Accordingly, to extend the overall system life and to normalize the power usage within the wireless speaker unit 150, the first and second wireless devices 160, 180 may be configured to change from the first setting to the second setting. In the second setting, the first wireless device 160 functions in the end mode, and the second wireless device 180 functions in the intermediary mode. As such, in the second setting, the second wireless device 180 receives the audio information from the base unit 110, and the second wireless device 180 is configured to produce an audible sound based on the audio information. The second wireless device 180 then forwards at least a portion of the audio information to the first wireless device 160, which is operating in the end mode. The first wireless device 160 receives the audio information and produces an audible sound based on the audio information. In one exemplary embodiment, when the first and second wireless devices 160, 180 switch modes, the mode switches may occur without any indication to the user or the base unit 110. In a further exemplary embodiment, one or both of the wireless devices 160, 180 may provide a signal to the user prior to the switch. This signal may be embodied as an audible signal, such as a tone or beep produced via one of the audio controllers 124, 174, 194, or a visual signal, such as a blinking light or message produced via one of the user interfaces 120, 166, 186. Additionally, one of the wireless devices 160, 180 may initiate a pause in the audio information from the base unit 110 prior to the switch. Typically, the wireless device in the intermediary mode (i.e., the first wireless device 160 in the first setting) sends a signal to the base unit 110 to pause the audio information prior to the switch. When the switch is complete, the wireless device in the intermediary mode (i.e., the second wireless device 180 in the second setting) sends a signal to the base unit 110 to resume audio information. As such, this results in a pause of the stereo music and/or telephone call while the wireless devices 160, 180 switch modes.

The setting change (and thus, the mode switch) may be triggered using the power monitor 170 and/or the power monitor 190. For example, the power monitor 170 may provide a trigger for the first wireless device 160 to switch modes when the power level of the power source reaches a threshold level. In one exemplary implementation, the threshold level may be at or about when 50% of the power source 168 is remaining. In other embodiments, the threshold level is between 40% and 60% or between 20% and 40% of the remaining level of the power source 168.

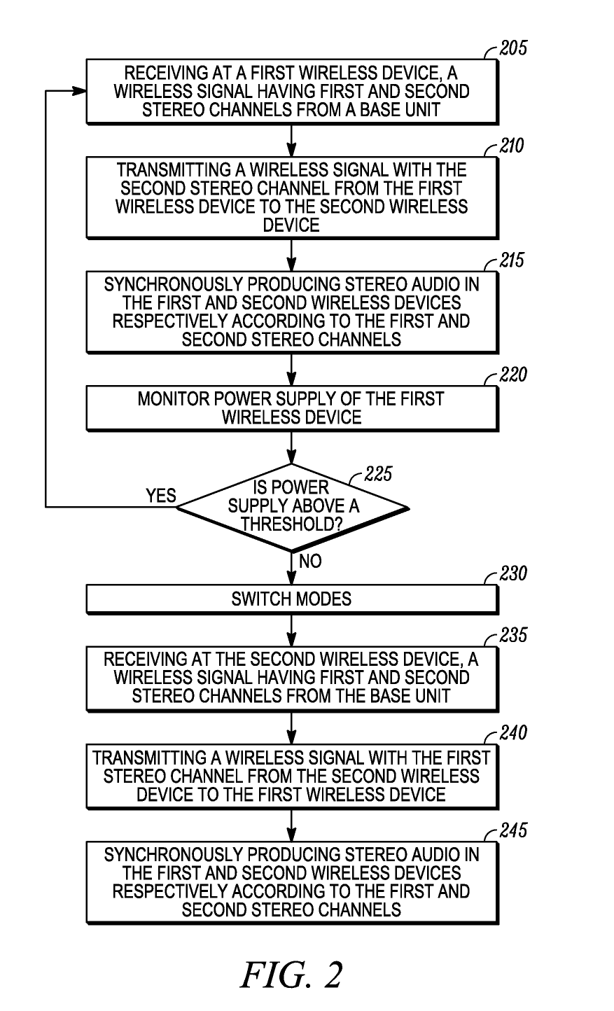

FIG. 2 is a flowchart of a method 200 for managing signal distribution in a wireless communication system 100 in accordance with an exemplary embodiment. In the description below, reference is additionally made to FIG. 1. In the exemplary embodiment described in FIG. 2, the wireless communication system 100 includes Bluetooth-enabled base unit 110 and wireless speaker unit 150, and the audio information communicated between the base unit 110 and the wireless speaker unit 150 includes first and second stereo channel signals (i.e., left and right stereo channel signals). The media format, in one embodiment, is the Bluetooth A2DP stereo format; however, any high quality audio or video encoding format may be alternatively used.

In a first step 205, the first wireless device 160 receives from the base unit 110 a signal having audio information for first and second stereo channels. As noted above, the first wireless device 160 and the base unit 110 may be linked or paired with one another by exchanging link parameter information via the radio modules 126, 176 to enable wireless communication. The signal from the base unit 110 may include a first stereo channel signal and a second stereo channel signal.

In a second step 210, the first wireless device 160 transmits to the second wireless device 180 a signal including the second stereo channel information, and may for example transmit the second stereo channel signal. As noted above, the first wireless device 160 and the second wireless device 180 may be linked or paired with one another by exchanging link parameter information via the radio modules 176, 196 to enable wireless communication. As such, in the first and second steps 205, 210, the wireless speaker unit 150 is in the first setting with the first wireless device 160 in the intermediary mode and the second wireless device 180 in the end mode. In general, this setting results in a higher power consumption for the first wireless device 160 as compared to the second wireless device 180 due to increased processing and/or transmitting responsibility.

In a third step 215, the wireless speaker unit 150 synchronously produces stereo sound in accordance with the audio information. In particular, the first wireless device 160 plays the first stereo channel, and the second wireless device 180 plays the second stereo channel. As noted above, the first and second wireless devices 160, 180 play the stereo channels via, for example, the respective audio controller 174, 194 in which a transducer drives a speaker to produce audible sound. It will be recognized that “play” or “playing” refers to producing an acoustic output that can be heard, for example by the human ear, in response to an electronic signal, and may accomplished utilizing transducers, amplifiers, audio signal processors, combinations thereof, or the like.

In a fourth step 220, the first wireless device 160 monitors the level of the power source 168 with the power monitor 170. Any suitable operating characteristic of the power source 168 may be monitored, including a voltage level, a current level, a power level, a fuel supply level (e.g., where the power source is a fuel cell), or a stored energy level.

In a fifth step 225, the first wireless device 160 determines whether the level of the power source 168 has fallen below a threshold level. If the level of the power source 168 is greater than the threshold level, the wireless speaker unit 150 continues to operate in the first setting such that the first wireless device 160 operates in the intermediary mode and the second wireless device operates in the end mode, and the method 200 returns to step 205.

If the power source 168 of the first wireless device 160 falls below the threshold level in the step 225, the method 200 progresses to step 230 in which the wireless speaker unit 150 changes from the first setting to the second setting. As such, in step 230, the first and second wireless devices 160, 180 will swap intermediary and end modes. In one exemplary embodiment, the first wireless device 160 may transfer the wireless link with the base unit 110 to the second wireless device 180. For example, the link module 172 of the first wireless device 160 may communicate the link parameters of the link with the base unit 110 to the link module 192 of the second wireless device 180. Upon receipt of the link parameters, the second wireless device 180 can listen in the link between the first wireless device 160 and the base unit 110. Then, the link modules 172, 192 may transfer control of the wireless link to the second wireless device 180. Upon this transfer of control, the first wireless device 160 may terminate the wireless link between the first wireless device 160 and the base unit 110, and the second wireless device 180 is in direct communication with the base unit 110 and communicates audio information from the base unit 110 to the first wireless unit 160. Accordingly, the second wireless device 180 is now in the intermediary mode and the first wireless device 160 is in the end mode such that the power demands of the first wireless device 160 are reduced. As noted above, the control transfer may occur without notice by the user. In another embodiment, the wireless devices 160, 180 may pause the music or telephone call to initiate the mode switch. The switch may be accompanied by audible indicators, such as voice prompts, tones, or beeps, and/or visual indicators, such as blinking or glowing LEDs on the wireless devices 160, 180.

Now that the modes of the first and second wireless devices 160, 180 have been switched, the method 200 continues to step 235 in which the second wireless device 180 receives and processes the transmission signal from the base unit that includes first and second stereo channel signals to be used to generate stereo audio signals.

In step 240, the second wireless device 180 transmits audio information including at least the first stereo channel in a signal transmitted to the first wireless device 160, and in step 245, the wireless speaker unit 150 synchronously produces stereo sound in accordance with the information in the signal transmitted from the first wireless device to the second wireless device. In particular, the first wireless devices 160 plays the first stereo channel signal, and the second wireless device 180 plays the second stereo channel signal to produce stereo audio.

By switching modes, the wireless speaker unit 150 conserves and optimizes power use. In effect, the wireless speaker unit 150 enables a balancing of the power requirements with the power available in each wireless device 160, 180. In this manner, the operational time period of the wireless speaker unit 150, without recharging or refueling, is extended beyond the time period of operation that would be expected in conventional wireless speaker units.

In an alternate embodiment, the method 200 may additionally monitor the level of power source 188 of the second wireless device 180, and the first and second wireless devices 160, 180 may exchange respective power levels. The link module 172 or link module 192 may then determine the appropriate mode based on a comparison the power levels. For example, the wireless device with the higher power level may be designated the intermediary mode device, and the wireless device with the lower power level may be designated the end mode device. Furthermore, if the power level of the end device is not higher than the power level of the intermediary device, when the power level if the intermediary device drops below the threshold, the devices may be controlled to not switch modes.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of managing signal distribution in a wireless speaker unit operable with a base unit and comprising a first battery powered wireless device and a second battery powered wireless device, the method comprising:
monitoring a power level of said first wireless device;
receiving, at said first wireless device, a first signal from the base unit if a power level of said first wireless device has not reached a threshold level;
transmitting wirelessly a second signal, derived from said first signal, from said first wireless device to said second wireless device if a power level of said first wireless device has not reached said threshold level;
receiving, at said second wireless device, said first signal from the base unit if said power level of said first wireless device reaches said threshold level; and
transmitting wirelessly a third signal, derived from said first signal, from said second wireless device to said first wireless device if said power level of said first wireless device reaches said threshold level.

2. The method of claim 1, further comprising
switching said first wireless device from an intermediary mode to an end mode if said power level of said first wireless device drops below said threshold level; and
switching said second wireless device from said end mode to said intermediary mode if said power level of said first wireless device drops below said threshold level.

3. The method of claim 1, wherein said first signal includes first and second stereo channels, and wherein said step of transmitting said second signal from said first wireless device to said second wireless device includes transmitting said second stereo channel from said first wireless device to said second wireless device.

4. The method of claim 4, further comprising synchronously
playing, in said first wireless device, said first stereo channel; and
playing, in said second wireless device, said second stereo channel.

5. The method of claim 4,
wherein said step of playing said first stereo channel includes producing an audio signal of said first stereo channel using a first transducer, and
wherein said step of playing said second stereo channel includes producing an audio signal of said second stereo channel using a second transducer.

6. The method of claim 1, further comprising
forming a first wireless radio frequency link between the base unit and said first wireless device and a second wireless radio frequency link between said first wireless device and said second wireless device; and
forming a third wireless radio frequency link between said second wireless device and the base unit if said power level of said first wireless device drops below said threshold level.

7. The method of claim 6, further comprising terminating said first wireless radio frequency link if said power level of said first wireless device drops below said threshold level.

8. The method of claim 2, wherein said power level of said first wireless device is a first power level, and the method further comprises monitoring a second power level of said second wireless device.

9. The method of claim 8, further comprising comparing said first power level and said second power level, and said steps of switching said first wireless device from an intermediary mode to an end mode and switching said second wireless device from said end mode to said intermediary mode only occur if said second power level is greater than said first power level.

10. A wireless communication system, comprising:
a first wireless device configured to operate in an intermediary mode such that said first wireless device receives a first stereo channel and a second stereo channel from a source, produces a signal for a transducer in accordance with said first stereo channel, and transmits said second stereo channel over a wireless link to a second wireless device;
said first wireless device including a power monitor operable to monitor a power level of a battery powering said first wireless device; and
said first wireless device including a controller operable to communicate a mode switch with the second wireless device in response to said power level dropping below a threshold level, said mode switch changing said mode of said first wireless device from intermediary mode to end mode such that said first wireless device ceases receiving said first signal and transmitting said second signal, and initiates receiving a third signal.

11. The wireless communication system of claim 10, further comprising the second wireless device, said second wireless device configured to operate in an end mode such that said second wireless device receives said second stereo channel from said first wireless device and plays said second stereo channel,
wherein said second wireless device is further configured to switch from said end mode to said intermediary mode such that said second wireless device receives said first stereo channel and said second stereo channel, plays said second stereo channel, and transmits said first stereo channel to said first wireless device, and
wherein said first wireless device is further configured to switch from said intermediary mode to said end mode such that said first wireless device receives said first stereo channel from said second wireless device, and plays said first stereo channel.

12. The wireless communication system of claim 11, wherein said first wireless device is a first wireless earpiece and said second wireless device is a second wireless earpiece.

13. The wireless communication system of claim 11, wherein said first wireless earpiece is a first wireless radio frequency communication earpiece and said second wireless earpiece is a second wireless radio frequency communication earpiece.

14. The wireless communication system of claim 11, further comprising a base unit configured to transmit said first channel and said second channel to said first wireless device in said intermediary mode and to transmit said first channel and said second channel to said second wireless device in said intermediary mode.

15. The wireless communication system of claim 14, wherein said first wireless device is configured to form a first wireless link with said base unit and to participate in transfer control of said first wireless link to said second wireless device in response to said power level of said first battery reaching said threshold level.

16. The wireless communication system of claim 14,
wherein said first wireless device is configured to form a first wireless radio frequency communication link with said base unit and a second wireless radio frequency communication link with said second wireless device, and
wherein said second wireless device is configured to form a third wireless radio frequency communication link with said base unit if said power level of said first wireless device reaches said threshold level.

17. The wireless communication system of claim 16, wherein said first wireless device is configured to terminate said first wireless radio frequency communication link if said power level of said first wireless device reaches said threshold level.

18. The wireless communication system of claim 11,
wherein said first wireless device further comprises a first battery and a first battery monitor configured to monitor a first power level of said first battery, said first battery monitor further configured to initiate said first wireless device switching from said intermediary mode to said end mode based on said first power level.

19. The wireless communication system of claim 18,
wherein said second wireless device further comprises a second battery and a second battery monitor configured to monitor a second power level of said second battery, and
wherein said first battery monitor further configured to initiate said first wireless device switching from said intermediary mode to said end mode based on a comparison between said first power level and said second power level.

20. A battery powered wireless speaker unit for a wireless stereo communication system operable with a base unit, the speaker unit comprising:
a first wireless device, comprising
a first battery;
a first power monitor configured to monitor a first power level of said first battery and to generate a trigger signal when said first power level falls below a threshold value; and
a first radio module configured to receive a first wireless signal from the base unit and to transmit a second wireless signal in response, said first wireless signal including a first stereo channel signal and a second stereo channel signal, and the second wireless signal including at least said second stereo channel signal;
a first audio controller configured to play said first stereo channel; and
said first wireless device responsive to said trigger signal to cease receiving said first signal and transmitting said second signal, and initiate receiving a third signal from the second wireless device.

21. The battery powered wireless speaker unit of claim 20, further including the second wireless device, said second wireless device comprising
a second battery;
a second radio module configured to receive said second wireless signal from said first wireless device; and
a second audio controller configured to control a transducer to produce audio signals in response to said first stereo channel,
wherein, in response to said trigger signal, said second radio module is configured to initiate receiving said first wireless signal from the base unit and transmitting said second wireless signal to said first radio module.

22. An integrated circuit for a wireless headset, comprising:
at least one radio frequency wireless transceiver;
a power monitor; and
a controller, said controller operable to control said at least one radio frequency wireless transceiver to selectively operate in at least one of an intermediary mode and an end mode,
wherein, in said intermediary mode, said at least one transceiver receives a first signal including at least right and left audio channels and transmits a second signal including at least one of said right and left audio channels to a paired device, and
wherein, in said end mode, said at least one transceiver does not process said first signal and receives a right or left audio channel from said paired device, and
wherein said controller is responsive to said power monitor detecting that a power source has dropped below a threshold level to change from said intermediary mode to said end mode.
